(19) United States
(12) Patent Application Publication
(10) Pub. No.: US 2006/0115658 A1
(43) Pub. Date: Jun. 1, 2006

(54) Method of producing porous low dielectric thin film

(75) Inventors: Sang Kook Mah, Seoul (KR); Hyeon Jin Shin, Suwon-Si (KR); Hyun Dam Jeong, Suwon-Si (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SAMSUNG CORNING CO., LTD., Suwon-si (KR)

(21) Appl. No.: 11/290,519

(22) Filed: Dec. 1, 2005

(30) Foreign Application Priority Data
Dec. 1, 2004 (KR) 2004-99933

(51) Int. Cl. B32B 27/28; C08G 77/04; C08L 83/04

(52) U.S. Cl. 428/447; 528/34

(57) ABSTRACT

A method of producing a porous low dielectric thin film is provided. The method comprises conducting hydrolysis and polycondensation of a polyreactive cyclic siloxane compound alone or in conjunction with one or more types of linear siloxane compounds or in conjunction with a Si monomer having an organic leg in the presence of water, organic hydroxide, and an organic solvent to produce a siloxane-based polymer, dissolving the polymer in water or the organic solvent to produce a coating solution, applying the coating solution on a substrate, and heat curing the resulting substrate. Even though a pore forming material is not used, it is possible to produce a porous low dielectric thin film.

### BACKGROUND OF THE DISCLOSURE

1. Field of the Disclosure

The present disclosure relates to a method of producing a porous low dielectric thin film. More particularly, the present invention pertains to a method of producing a porous low dielectric thin film, in which a polyreactive cyclic siloxane compound is subjected to hydrolysis and polycondensation alone or in conjunction with one or more types of linear siloxane compounds or in conjunction with a Si monomer having an organic leg in the presence of organic hydroxide, water, and an organic solvent to produce a siloxane-based polymer, the polymer is dissolved in water or the organic solvent to produce a coating solution, and the coating solution is applied on a substrate and is heat cured to produce the porous low dielectric thin film.

2. Description of the Related Art

In accordance with increasing integration in the semiconductor field, it is necessary to reduce the accumulation capacitance of an interlayer insulating film so as to reduce resistance and an electric capacitance in wiring, because the performance of a device depends on the wiring speed. To achieve this, efforts have been made to use a material having a low dielectric constant as an interlayer insulating film. For example, U.S. Pat. Nos. 3,615,272, 4,399,266, and 4,999,397 disclose polysilsesquioxane, which is capable of being used in SOD (spin on deposition), has a dielectric constant of 2.5-3.1, and replaces SiO₂, which has a dielectric constant of 4.00 and is used in conventional CVD (chemical vapor deposition). Furthermore, U.S. Pat. No. 5,965,679 discloses polyphenylene as an organic polymer having a dielectric constant of 2.65-2.70. However, they do not have a sufficiently low dielectric constant to produce a high speed device requiring a very low dielectric constant of 2.50 or less.

Meanwhile, Japanese Patent Laid-Open Publication No. 2003-249495 discloses a coating composition for producing an interlayer insulating film, which comprises a silica precursor including one or more compounds selected from the group consisting of alkoxy silane and hydrolysis materials and polycondensates thereof, an organic solvent, and a metal selected from the group consisting of Fe, Na, K, Ti, Cr, Co, Ni, Cu, Zn, W, and Bi in a maximum content of 1 ppm. Additionally, U.S. Pat. No. 6,630,696 discloses two types of continuously connected silica zeolite thin films, having a low dielectric insulating film comprising Si(OR)₄, which has micropores having an average pore size of 5.5 Å and a pore volume of about 0.15-0.21 cm³/g and mesopores having an average pore size of 2-20 nanometers and a pore volume of about 0.1-0.45 cm³/g. However, the above technologies disclosing methods using zeolites are problematic in that, since a strong base is present in a product solution and stabilizes particles, if it is mixed with another solvent, such as PGMEA (propylene glycol methyl ether acetate), gelation occurs.

### SUMMARY OF THE DISCLOSURE

Accordingly, an object of the present invention is to provide a method of producing a porous thin film which has a desirably low dielectric constant and excellent mechanical properties without using a pore forming material.

In order to accomplish the above object, an aspect of the present invention provides a method of producing a porous low dielectric thin film. The method comprises (i) conducting hydrolysis and polycondensation of the cyclic siloxane compound of Formula 1 alone or in conjunction with a monomer of Formula 2 or 3 in the presence of organic hydroxide, water, and an organic solvent to produce a siloxane-based polymer; (ii) mixing the siloxane-based polymer with water or the organic solvent to produce a coating solution; and (iii) applying the coating solution on a substrate and heat curing the resulting substrate.

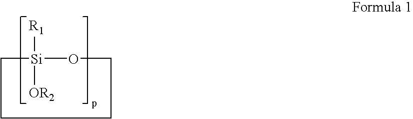

In Formula 1, R₁ is a hydrogen atom, C₁-C₃ alkyl groups, or C₆-C₁₅ aryl groups, R₂ is a hydrogen atom, C₁-C₃ alkyl groups, or SiX₁X₂X₃ (X₁, X₂, and X₃ are independently a hydrogen atom, C₁-C₃ alkyl groups, C₁-C₁₀ alkoxy groups, or a halogen atom, at least one of which is a functional group capable of being hydrolyzed), and p is an integer ranging from 3 to 8.
(R₁)ₙSi(OR₂)₄₋ₙ Formula 2

In Formula 2, R₁ is a hydrogen atom, C₁-C₃ alkyl groups, a halogen group, or C₆-C₁₅ aryl groups, R₂ is a hydrogen atom, C₁-C₃ alkyl groups, or C₆-C₁₅ aryl groups, at least one of R₁ and OR₂ is a functional group capable of being hydrolyzed, and n is an integer ranging from 0 to 3.
X₃X₂X₁Si-M-SiX₁X₂X₃ Formula 3

In Formula 3, X₁, X₂, and X₃ are independently C₁-C₃ alkyl groups, C₁-C₁₀ alkoxy groups, or a halogen atom, at least one of which is a functional group capable of being hydrolyzed, and M is C₁-C₁₀ alkylene groups or C₆-C₁₅ arylene groups.

### BRIEF DESCRIPTION OF THE DRAWING

The above and other objects, features and advantages of the present invention will be more clearly understood from the following detailed description taken in conjunction with the accompanying drawing, in which:

FIG. 1 illustrates a spectrum taken using an infrared spectrophotometer to confirm the formation of a network structure of a siloxane-based polymer produced according to an embodiment of the present invention.

### DESCRIPTION OF THE PREFERRED EMBODIMENTS

Hereinafter, a detailed description will be given of a method of producing a porous low dielectric thin film according to the present invention.

In order to produce the porous thin film of the present invention, first, the siloxane compound disclosed in the following Formula 1 (hereinafter, referred to as ‘monomer (a)’) is subjected to hydrolysis and polycondensation reactions alone or in conjunction with one or more compounds, selected from the group consisting of the linear siloxane compound disclosed in the following Formula 2 (hereinafter, referred to as ‘monomer (b)’) and a Si monomer having an organic leg and disclosed in the following Formula 3 (hereinafter, referred to as ‘monomer (c)’), in the presence of organic hydroxide, water, and an organic solvent to produce a siloxane-based polymer.

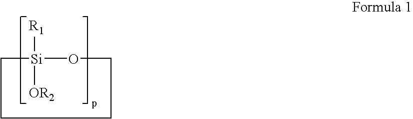

In Formula 1, R₁ is a hydrogen atom, C₁-C₃ alkyl groups, or C₆-C₁₅ aryl groups, R₂ is a hydrogen atom, C₁-C₃ alkyl groups, or SiX₁X₂X₃ (X₁, X₂, and X₃ are independently a hydrogen atom, C₁-C₃ alkyl groups, C₁-C₁₀ alkoxy groups, or a halogen atom, at least one of which is a functional group capable of being hydrolyzed), and p is an integer ranging from 3 to 8.
(R₁)ₙSi(OR₂)₄₋ₙ Formula 2

In Formula 2, R₁ is a hydrogen atom, C₁-C₃ alkyl groups, a halogen group, or C₆-C₁₅ aryl groups, R₂ is a hydrogen atom, C₁-C₃ alkyl groups, or C₆-C₁₅ aryl groups, at least one of R₁ and OR₂ is a functional group capable of being hydrolyzed, and n is an integer ranging from 0 to 3.
X₃X₂X₁Si-M-SiX₁X₂X₃ Formula 3

In Formula 3, X₁, X₂, and X₃ are independently C₁-C₃ alkyl groups, C₁-C₁₀ alkoxy groups, or a halogen atom, at least one of which is a functional group capable of being hydrolyzed, and M is C₁-C₁₀ alkylene groups or C₆-C₁₅ arylene groups.

Examples of the monomer (a) shown in Formula 1 include the compounds of Formulae 4 to 9.

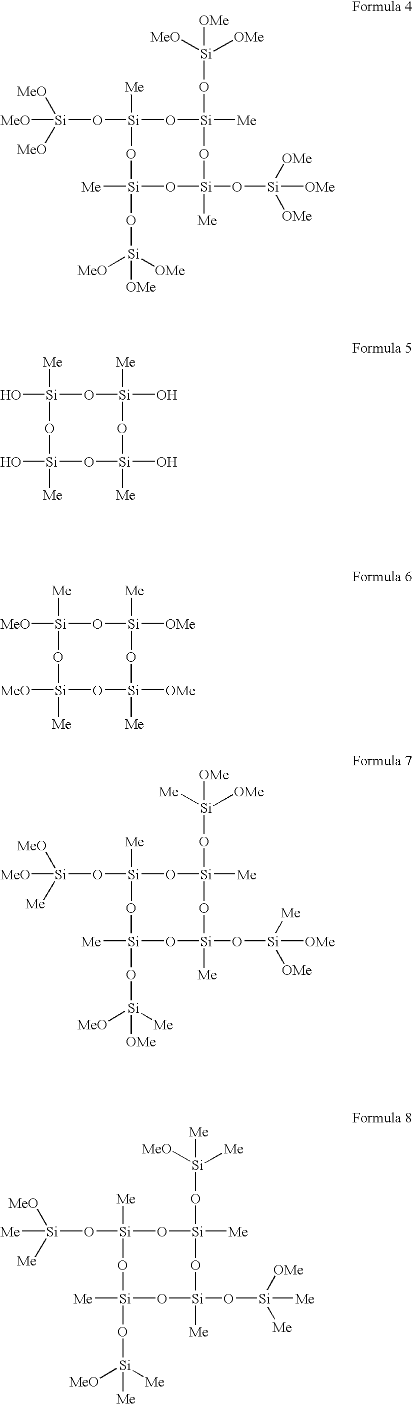

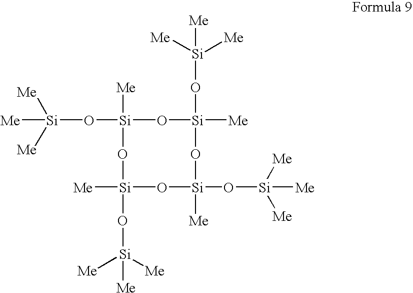

Examples of the monomer (b) shown in Formula 2 include the compounds of Formulae 10 to 12.

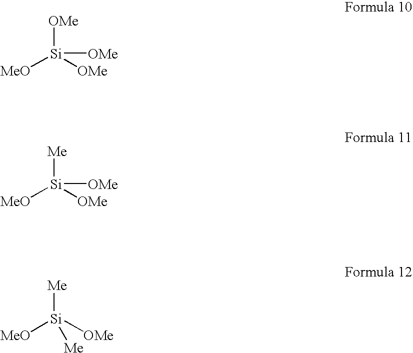

Examples of the monomer (c) shown in Formula 3 include the compounds of Formulae 13 and 14.

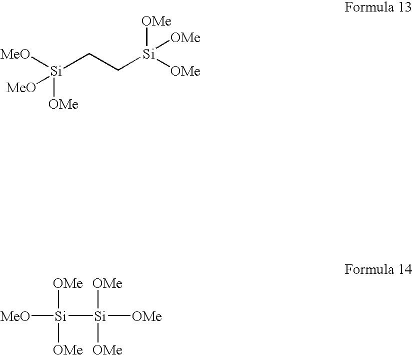

When the monomer (a) is copolymerized along with one or more selected from the group consisting of the monomer (b) and the monomer (c) to produce the siloxane-based polymer used to produce the porous thin film of the present invention, the molar ratio of the monomers can be varied and is determined upon a consideration of the physical properties of the insulating film to be produced. For example, if the monomer a is copolymerized with the monomer b or the monomer c as a comonomer, the weight ratio of the two monomers may be 0.01-10.

Meanwhile, illustrative, but non-limiting, examples of the organic hydroxide used to produce the siloxane-based polymer include alkylammonium hydroxides, such as tetramethylammonium hydroxide, tetraethylammonium hydroxide, tetrapropylammonium hydroxide, tetrabutylammonium hydroxide, and mixtures thereof. As well, it is preferable that the amount of organic hydroxide used to produce the siloxane-based polymer of the present invention be 50% or less based on the total weight of monomers used to produce the polymer in order to achieve the production of the porous thin film.

Illustrative, but non-limiting, examples of the organic solvent which is used to produce the siloxane-based polymer according to the present invention include an aliphatic hydrocarbon solvent, such as hexane or heptane; an aromatic hydrocarbon solvent, such as anisole, mesitylene, or xylene; a ketone-based solvent, such as methyl isobutyl ketone, 1-methyl-2-pyrrolidinone, cyclohexanone, or acetone; an ether-based solvent, such as tetrahydrofuran, isopropyl ether, or propylene glycol propyl ether; an acetate-based solvent, such as ethyl acetate, butyl acetate, or propylene glycol methyl ether acetate; an alcohol-based solvent, such as isopropyl alcohol or butyl alcohol; an amide-based solvent, such as dimethylacetamide or dimethylformamide; a silicon-based solvent; or mixtures thereof.

The amount of water used in the hydrolysis and polycondensation reactions to produce the siloxane-based polymer of the present invention, is preferably 0.1-1000 equivalents per 1 equivalent of all monomers. The reactions are conducted at approximately 0-200° C., and preferably at approximately 50-110° C., for approximately 0.1-100 hours, and preferably approximately 3-48 hours.

In the present invention, since the siloxane-based polymer is produced using organic hydroxide, the siloxane-based polymer is produced in the form of a porous precursor, thus it is possible to produce a porous thin film even though a pore forming material is not used.

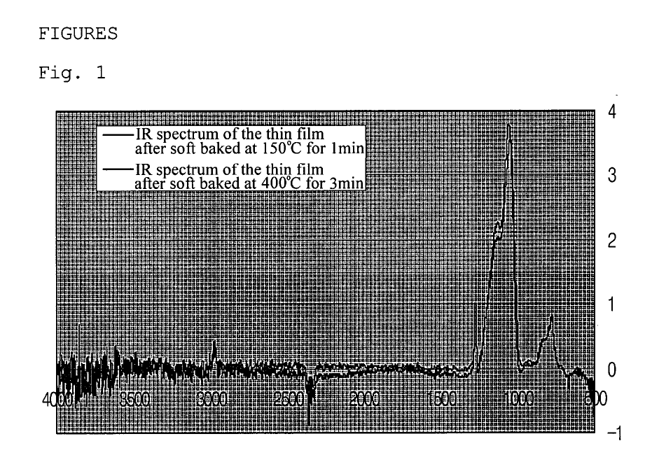

Meanwhile, FIG. 1 illustrates a spectrum taken using an infrared spectrophotometer to confirm the formation of a network structure of a siloxane-based polymer produced according to an embodiment of the present invention. From FIG. 1, it can be seen that, if the siloxane-based polymer of the present invention is dissolved in an organic solvent to apply on a substrate and then soft baked at a low temperature of 150° C., little Si—OH (an absorption peak at 3000-3500 nm) is observed, and the network structure is almost entirely accomplished.

The siloxane-based polymer thus produced may be subjected to a work-up process using water prior to the subsequent step (ii), if necessary. In other words, an organic solvent, such as diethylether or tetrahydrofuran, may be added to the siloxane-based polymer, and the resulting polymer may be rinsed with a predetermined amount of water a few times to remove remaining organic hydroxide therefrom.

After step (i), or, if necessary, after the siloxane-based polymer produced in step (i) is subjected to the work-up process using water, the siloxane-based polymer is mixed with water or the organic solvent to produce a coating solution in step (ii).

The content of siloxane-based polymer as a solid in the coating solution is not critical, and may be approximately 3-70 wt % based on the total weight of the composition.

Meanwhile, the organic solvent capable of being used to produce the coating solution of the present invention is not critical with all of the above-mentioned organic solvents being preferred for the production of the siloxane-based polymer.

Next, in step (iii), the coating solution produced in step (ii) is applied on the substrate and then is heat cured to produce the porous low dielectric thin film according to the present invention.

The substrate used to produce the insulating film of the present invention is not critical so long as realization of the object of the present invention is achieved, and any substrate, for example, a glass substrate, a silicon wafer, or a plastic substrate, may be used depending on the application as long as it is capable of enduring heat curing conditions.

Illustrative, but non-limiting, examples of methods of applying the coating solution, which are useful in the present invention, include a spin coating method, a dip coating method, a spray coating method, a flow coating method, and a screen printing method. The spin coating method is most preferable from the standpoint of convenience and uniformity. If the spin coating method is conducted, it is preferable that the spin speed be controlled within the range of approximately 800 to 5,000 rpm.

After the application is completed, the solvent may be evaporated to dry the film if necessary. The drying of the film may be achieved by simple exposure to the environment, and the application of a vacuum at an early step of the curing process, or by heating at a relatively low temperature of approximately 200° C. or less.

Subsequently, the film is heat cured at approximately 150-600° C., and preferably at approximately 200-450° C., for approximately 1-180 min to form an insoluble film having no cracks. The term “film having no cracks” means a film on which no cracks visible to the naked eyes are observed using an optical microscope at 1000× magnification. The term “insoluble film” means a film which is essentially insoluble in a solvent when dipping the siloxane-based polymer therein to form a film thereon or a solvent used to apply a resin coating thereon.

The insulating film produced according to the present invention has porosity of approximately 5% or more, which corresponds to a low dielectric constant, and excellent mechanical properties, such as modulus, even though a pore forming material is not used, thus it is useful as an interlayer insulating film of a semiconductor.

A better understanding of the present invention may be obtained through the following examples which are set forth to illustrate, but are not to be construed as the limit of the present invention.

First, a detailed description will be given of methods of evaluating performance of an insulating film produced according to the following examples.

Measurement of the Thickness and Dielectric Constant of a Thin Film

After a silicon heat oxidation film was applied on a boron-doped p-type silicon wafer to a thickness of 3000 Å, titanium, an aluminum thin film, and titanium were deposited to thicknesses of 100 Å, 2000 Å, and 100 Å, respectively, using a metal evaporator, and an insulating film was formed thereon. Circular titanium and aluminum thin films having a diameter of 1 mm were deposited to thicknesses of 100 Å and 5000 Å on the insulating film using a hard mask in which the electrode diameter was designed to be 1 mm to create a low dielectric thin film for measuring a dielectric constant having a MIM (metal-insulator-metal) structure. The capacitance of the resulting thin film was measured using a PPRECISION LCR METER (HP4284A) equipped with a probe station (micromanipulator 6200 probe station) at frequencies of about 10 kHz, 100 kHz, and 1 MHz, the thickness of the thin film was measured using a prism coupler, and the dielectric constant was calculated using the following equation.
k=C×d/ε₀×A

(wherein, k is the dielectric constant, C is the capacitance, ε₀ is the dielectric constant of a vacuum (ε₀=8.8542×10⁻¹² Fm⁻¹), d is the thickness of the insulating film, and A is the contact sectional area of the electrode).

Modulus

Modulus was determined by quantitatively analyzing the insulating film using a nanoindenter II manufactured by MTS Inc. In detail, the thin film was indented using the nanoindenter, and the modulus of the thin film was determined when the indent thickness was 10% of the thickness of the thin film. The thickness of the thin film was measured using the prism coupler. In the examples and comparative examples of the present invention, the insulating film was indented at 9 portions thereof to obtain a modulus from a mean value so as to assure reliability.

Synthesis of a Monomer

(1) Synthesis of a Cyclic Siloxane-Based Monomer (A-1)

41.6 mmol (10.00 g) of 2,4,6,8-tetramethyl-2,4,6,8-cyclotetrasiloxane were loaded in a flask, 100 ml of tetrahydrofuran were fed thereinto to conduct dilution, and 200 mg of 10 wt % Pd/C (palladium/charcoal) were added thereto. Subsequently, 177.8 mmol (3.20 ml) of distilled water were added thereto, and hydrogen gas generated during this procedure was removed. After the reaction was conducted at normal temperature for 15 hours, the reaction solution was filtered using celite and MgSO₄, and the filtrate was left at a reduced pressure of about 0.1 torr to remove volatile materials so as to synthesize the colorless liquid monomer (A-1) of Formula 15.

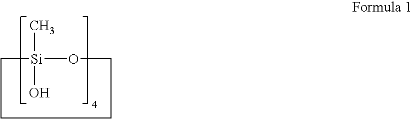

The ¹H NMR(300 MHz) measurement results of the resulting monomer (acetone-d₆ solution) are as follows: δ 0.067(s, 12H, 4*[—CH₃]), 5.52(s, 4H, 4*[—OH]).

(2) Synthesis of a Cyclic Siloxane-Based Monomer (A-2)

177.8 mmol (13.83 g) of triethylamine were added to a solution in which 41.6 mmol (12.6 g) of liquid product created in synthesis example 1 were diluted with 200 ml of tetrahydrofuran. The temperature of the solution was reduced to 0° C., 177.8 mmol (25.0 g) of chlorotrimethoxysilane were slowly added thereto, and the temperature was slowly increased to room temperature to conduct a reaction for 15 hours. The reaction solution was filtered using celite, and the filtrate was left at a reduced pressure of about 0.1 torr to remove volatile materials and thus be concentrated so as to produce the colorless liquid monomer of the following Formula 4 (A-2).

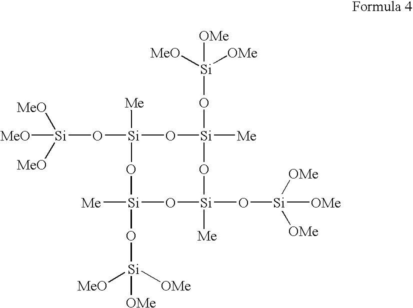

The ¹H NMR(300 MHz) measurement results of the resulting monomer are as follows: δ 0.092(s, 12H, 4*[—CH₃]), 3.58(s, 9H, 4*[—CH₃]).

Production of Polymers (P-1 to P-4) and Production of Coating Solutions (C-1 to C-4)

The cyclic siloxane-based monomer (A-2) produced in synthesis example 2, methanol, and water were loaded in a flask in amounts as described in the following Table 1, and 10 wt % tetrapropyl ammonium hydroxide (TPAOH) aqueous solution was slowly dropped using a syringe in an amount given in Table 1 while agitation was conducted. After agitation was conducted at room temperature for an additional 30 min, the flask was slowly heated to 70° C. to conduct a reaction for 8 hours. After the temperature of the reactants was cooled to room temperature, filtration was conducted using a filter having a pore size of 0.2 μm, the filtrate was loaded in a flask, and methyl trimethoxy silane (MTMS) was slowly dropped in an amount described in Table 1. After agitation was conducted at room temperature for an additional 30 min, the temperature was slowly increased to 70° C., and the reaction was carried out for 2 hours. After the reaction was completed, the product was sampled in an amount of 20 ml and then put in another flask. 20 ml of tetrahydrofuran and 10 ml of water were added to this flask, and a hydrochloric acid aqueous solution (0.001 mol/l) was slowly added thereto in the amount given in Table 1 to neutralize basicity of the reaction solution. The reaction solution was put in a separatory funnel, diethylether and tetrahydrofuran were added in amounts of 20 ml, and washing was conducted three times with water in an amount of ½ of the total amount of solvent. 5 ml of propylene glycol methyl ether acetate (PGMEA) and 5 ml of propylene glycol propyl ether (PGP) were added to the resulting siloxane-based polymers (P-1 to P-4) which were not dried, and highly volatile materials were removed at a reduced pressure to produce transparent coating solutions (C-1 to C-4).

TABLE 1

| | A-2 | | TPAOH | | Hydrochloric |
|---|---|---|---|---|---|
| | compound | Methanol | solution | MTMS | acid aqueous |
| Polymer | (g) | (g) | (g) | (ml) | solution(ml) |
| P-1 | 6 | 18 | 25 | 0 | 5 |
| P-2 | 6 | 18 | 25 | 0.67 | 5 |
| P-3 | 6 | 18 | 25 | 0.89 | 5 |
| P-4 | 6 | 18 | 25 | 1.11 | 5 |

Production of the Insulating Film

The coating solution was applied on a silicon wafer through a spin coating process at 2000 rpm for 30 sec, and preliminarily heated on a hot plate in a nitrogen atmosphere at 150° C. for 1 min and at 300° C. for 1 min to be dried, thereby producing a film. The film was heat treated in a vacuum at 420° C. (temperature increase rate: 3° C./min) for 1 hour to produce the insulating film. The thickness, refractive index, dielectric constant, and modulus of the resulting insulating film were measured, and the results are described in Table 2.

TABLE 2

| | Heat | Thick- | | Dielectric | |
|---|---|---|---|---|---|
| Coating | treatment | ness | Refractive | constant | Modulus |
| solution | conditions | (Å) | index(RI) | (k) | (GPa) |
| C-1 | 420° C. vacuum | 6.552 | 1.2726 | 2.80 | 5.5 |
| C-2 | 420° C. vacuum | 6.893 | 1.3094 | 2.33 | 7.1 |
| C-3 | 420° C. vacuum | 6.012 | 1.2904 | 2.20 | 5.5 |
| C-4 | 420° C. vacuum | 10.933 | 1.2922 | 2.35 | 4.3 |

From Table 2, it can be seen that the porous thin film produced according to the method of the present invention has a low dielectric constant and excellent mechanical properties.

According to the method of the present invention, it is possible to produce a porous low dielectric thin film without using a pore forming material. The resulting thin film is useful as an insulating film in a semiconductor device field.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of producing a porous low dielectric thin film, comprising:
(i) conducting hydrolysis and polycondensation of a siloxane compound of Formula 1 alone or in conjunction with a monomer of Formula 2 or 3 in presence of organic hydroxide, water, and an organic solvent to produce a siloxane-based polymer;
(ii) mixing the siloxane-based polymer with water or the organic solvent to produce a coating solution; and
(iii) applying the coating solution on a substrate and heat curing the resulting substrate, 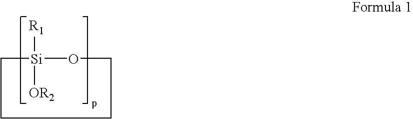
wherein R₁ is a hydrogen atom, C₁-C₃ alkyl groups, or C₆-C₁₅ aryl groups, R₂ is a hydrogen atom, C₁-C₃ alkyl groups, or SiX₁X₂X₃ (X₁, X₂, and X₃ are independently a hydrogen atom, C₁-C₃ alkyl groups, C₁-C₁₀ alkoxy groups, or a halogen atom, at least one of which is a functional group capable of being hydrolyzed), and p is an integer ranging from 3 to 8,
(R₁)ₙSi(OR₂)₄₋ₙ Formula 2
wherein R₁ is a hydrogen atom, C₁-C₃ alkyl groups, a halogen group, or C₆-C₁₅ aryl groups, R₂ is a hydrogen atom, C₁-C₃ alkyl groups, or C₆-C₁₅ aryl groups, at least one of R₁ and OR₂ is a functional group capable of being hydrolyzed, and n is an integer ranging from 0 to 3,
X₃X₂X₁Si-M-SiX₁X₂X₃ Formula 3
wherein X₁, X₂, and X₃ are independently C₁-C₃ alkyl groups, C₁-CIO alkoxy groups, or a halogen atom, at least one of which is a functional group capable of being hydrolyzed, and M is C₁-C₁₀ alkylene groups or C₆-C₁₅ arylene groups.

2. The method as set forth in claim 1, further comprising removing organic hydroxide from the siloxane-based polymer which is produced in step (i) through a work-up process using water.

3. The method as set forth in claim 1, wherein the organic hydroxide is alkyl ammonium hydroxide.

4. The method as set forth in claim 1, wherein an amount of the organic hydroxide used is within a range of 50% based on a total weight of the monomer.

5. The method as set forth in claim 1, wherein the organic solvent is an aliphatic hydrocarbon solvent, including hexane and heptane; an aromatic hydrocarbon solvent, including anisole, mesitylene, and xylene; a ketone-based solvent, including methyl isobutyl ketone, 1-methyl-2-pyrrolidinone, cyclohexanone, and acetone; an ether-based solvent, including tetrahydrofuran, isopropyl ether, and propylene glycol propyl ether; an acetate-based solvent, including ethyl acetate, butyl acetate, and propylene glycol methyl ether acetate; an alcohol-based solvent, including isopropyl alcohol and butyl alcohol; an amide-based solvent, including dimethylacetamide and dimethylformamide; a silicon-based solvent; or mixtures thereof.

6. The method as set forth in claim 1, wherein the content of solids in the coating solution is 3 to 70 wt % based on a total weight of the coating solution.

7. The method as set forth in claim 1, wherein the heat curing is conducted at approximately 150-600° C. for approximately 1-180 min in the step (iii).

8. An insulating film produced through the method of claim 1.

9. A semiconductor device which comprises an insulating film produced by the method of claim 1.

10. The method as set forth in claim 2, wherein the organic hydroxide is alkyl ammonium hydroxide.

11. The method as set forth in claim 2, wherein an amount of the organic hydroxide used is within a range of 50% based on a total weight of the monomer.

12. The method as set forth in claim 2, wherein the organic solvent is an aliphatic hydrocarbon solvent, including hexane and heptane; an aromatic hydrocarbon solvent, including anisole, mesitylene, and xylene; a ketone-based solvent, including methyl isobutyl ketone, 1-methyl-2-pyrrolidinone, cyclohexanone, and acetone; an ether-based solvent, including tetrahydrofuran, isopropyl ether, and propylene glycol propyl ether; an acetate-based solvent, including ethyl acetate, butyl acetate, and propylene glycol methyl ether acetate; an alcohol-based solvent, including isopropyl alcohol and butyl alcohol; an amide-based solvent, including dimethylacetamide and dimethylformamide; a silicon-based solvent; or mixtures thereof.

13. The method as set forth in claim 2, wherein the content of solids in the coating solution is 3 to 70 wt % based on a total weight of the coating solution.

14. The method as set forth in claim 2, wherein the heat curing is conducted at approximately 150-600° C. for approximately 1-180 min in the step (iii).

15. An insulating film produced through the method of claim 2.

16. A semiconductor device which comprises an insulating film produced by the method of claim 2.
